(19) United States
(12) Patent Application Publication
(10) Pub. No.: US 2018/0331791 A1
(43) Pub. Date: Nov. 15, 2018

(54) DATA TRANSMISSION METHOD AND SYSTEM, MASTER COMMUNICATION DEVICE, AND SLAVE COMMUNICATION DEVICE

(71) Applicant: TENDYRON CORPORATION, Beijing (CN)

(72) Inventor: Dongsheng LI, Beijing (CN)

(21) Appl. No.: 15/777,193

(22) PCT Filed: Nov. 18, 2016
(86) PCT No.: PCT/CN2016/106441

§ 371 Date: May 17, 2018

(30) Foreign Application Priority Data
Nov. 18, 2015 (CN) 201510795867.5

(51) Int. Cl. H04L 1/18; H04W 56/00

(52) U.S. Cl. CPC H04L 1/1848; H04W 56/0015; H04W 84/20; H04L 1/1858; H04L 1/1835

(57) ABSTRACT

Provided are a data transmission method and system, a master communication device and a slave communication device. The data transmission method comprises: step A, the master communication device dividing data to be transmitted into data packets; step B, the master communication device sequentially transmitting the data packets to the slave communication device until the last data packet is transmitted; step C, the master communication device judging whether information transmitted by the slave communication device is received within a first pre-set time, and executing step D1 under the condition that the information transmitted by the slave communication device is not received within the first pre-set time; and step D1, the master communication device transmitting control information to the slave communication device and instructing the slave communication device to respond to the control information.

### CROSS-REFERENCE TO RELATED APPLICATIONS

This application is a national phase application of International application No. PCT/CN2016/106441, filed on Nov. 18, 2016, which claims a priority to Chinese Patent Application No. 201510795867.5, filed with the State Intellectual Property Office of P. R. China on Nov. 18, 2015, titled with “data transmission method and system, master communication device, and slave communication device”, the entire content of which is incorporated herein by reference.

### FIELD

The present disclosure relates to a communication field, and more particularly, to a data transmission method and system, a master communication device and a slave communication device.

### BACKGROUND

At present, during data transmission, when a communication sender sends data to a communication receiver, the communication sender often sends only one data packet at a time. After the communication receiver receives the data packet, the communication receiver may feed back a piece of information to the communication sender when the data packet is received successfully. When the data packet is not received successfully (for example, the received data packet is incomplete), the communication receiver may request the communication sender to resend the data packet. In this case, the communication sender may resend the data packet when the communication sender receives the resend request sent by the communication receiver.

However, the data transmission in this way requires one response each time one data packet is sent, resulting in a decrease in data interaction rate. When fast communication is required, it is unable to meet requirements of the fast communication.

### SUMMARY

Embodiments of the present disclosure provide a data transmission method. The method includes: step A, dividing, by a master communication device, data to be sent into data packets; step B, sending, by the master communication device, the data packets to a slave communication device in turn until a last data packet is sent; step C, determining, by the master communication device, whether information sent by the slave communication device is received within a first preset time, and performing step D1 when the information sent by the slave communication device is not received within the first preset time; and step D1, sending, by the master communication device, control information to the slave communication device to indicate the slave communication device to respond to the control information.

Embodiments of the present disclosure provide a data transmission method. The method includes: receiving, by a slave communication device, data packets sent by a master communication device; determining, by the slave communication device, whether the data packets are complete; sending first control information to the master communication device when the slave communication device determines that the data packets are incomplete, wherein the first control information is used to indicate retransmission of the master communication device; and parsing, by the slave communication device, the data packets to obtain data transmitted by the data packets, processing the data to obtain response data, and sending the response data to the master communication device, when the slave communication device determines that the data packets are complete.

Embodiments of the present disclosure provide a master communication device, including one or more processors. The one or more processors include: a dividing module, configured to divide data to be sent into data packets; a sending module, configured to send the data packets to a slave communication device in turn, and to start a first timer when a last data packet is sent; the first timer, configured to count a time duration of a first preset time; a receiving module, configured to receive information sent by the slave communication device; and a first determining module, configured to determine whether the receiving module receives the information sent by the slave communication device before the first timer expires, and to trigger the sending module to send control information to the slave communication device to indicate the slave communication device to respond to the control information when the receiving module does not receive the information sent by the slave communication device before the first timer expires.

Embodiments of the present disclosure provide a slave communication device, including one or more processors. The one or more processors include: a receiving module, configured to receive data packets sent by a master communication device; a determining module, configured to determine whether the data packets are complete; a sending module, configured to send first control information to the master communication device when the determining module determines that the data packets are incomplete, wherein the first control information is used to indicate retransmission of the master communication device; and a processing module, configured to, when the determining module determines that the data packets are complete, parse the data packets to obtain data transmitted by the data packets, to process the data to obtain response data and to send the response data to the master communication device through the sending module.

Embodiments of the present disclosure provide a data transmission system, including the master communication device described above and the slave communication device described above.

### BRIEF DESCRIPTION OF THE DRAWINGS

To describe the technical solutions in the embodiments of the present disclosure more clearly, the accompanying drawings required for describing the embodiments are introduced briefly in the following. Obviously, the accompanying drawings in the following description are only some embodiments of the present disclosure, and persons of ordinary skill in the art may also derive other drawings from these accompanying drawings without creative efforts.

FIG. 1 is a schematic diagram of a data transmission system according to an embodiment of the present disclosure.

FIG. 2 is a schematic diagram of a master communication device according to an embodiment of the present disclosure.

FIG. 3 is a schematic diagram of a master communication device according to another embodiment of the present disclosure.

FIG. 4 is a schematic diagram of a master communication device according to yet another embodiment of the present disclosure.

FIG. 5 is a schematic diagram of a master communication device according to still another embodiment of the present disclosure.

FIG. 6 is a schematic diagram of a slave communication device according to an embodiment of the present disclosure.

FIG. 7 is a flow chart of a data transmission method of a master communication device according to an embodiment of the present disclosure.

FIG. 8 is a flow chart of a data transmission method of a slave communication device according to an embodiment of the present disclosure.

### DETAILED DESCRIPTION

The technical solutions in the embodiments of the present disclosure are clearly and completely described in the following with reference to the accompanying drawings in the embodiments of the present disclosure. Obviously, the embodiments in the following description are merely a part rather than all of the embodiments of the present disclosure. Based on the embodiments of the present disclosure, all other embodiments obtained by persons of ordinary skill in the art without creative efforts shall fall within the protection scope of the present disclosure.

In the description of the present disclosure, it should be noted that, terms such as “central”, “longitudinal”, “lateral”, “upper”, “lower”, “front”, “rear”, “left”, “right”, “vertical”, “horizontally”, “top”, “bottom”, “inner”, “outer” should be construed to refer to the orientation or position as then described or as illustrated in the drawings, and are merely for convenience of describing or simplifying the description of the present disclosure, rather than indicating or implying that the device or element referred to must have a particular orientation, and thus should not be construed as limiting the present disclosure. In addition, terms such as “first” and “second” are used herein for purposes of description and are not intended to indicate or imply relative importance or significance.

In the description of the present disclosure, it should be noted that, unless specified or limited otherwise, the terms “mounted,” “connected,” and “coupled” and variations thereof are used broadly and encompass such as fixed or removable mountings, connections and couplings, mechanical or electrical mountings, connections and couplings, also can be direct and indirect mountings, connections, and couplings, and further can be inner mountings, connections and couplings of two components via intermediary, which can be understood by persons of ordinary skill in the art according to the detail embodiment of the present disclosure.

In the following, embodiments of the present disclosure will be described in detail with reference to the accompanying drawings.

### Embodiment One

Embodiments of the present disclosure provide a data transmission system.

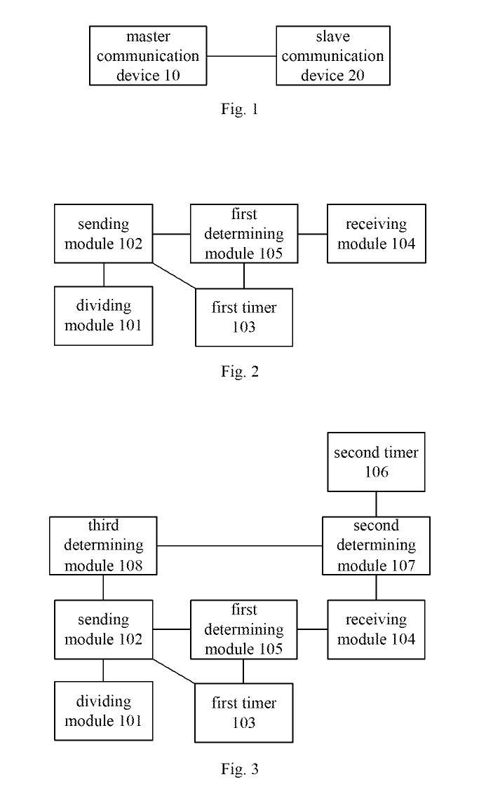

FIG. 1 is a schematic diagram of a data transmission system according to an embodiment of the present disclosure. As illustrated in FIG. 1, the data transmission system 100 includes a master communication device 10 and a slave communication device 20. The master communication device 10 may include a first external interface formed by a first pin and a second pin. The slave communication device 20 may include a second external interface formed by a third pin and a fourth pin. The first external interface of the master communication device 10 is connected with the second external interface of the slave communication device 20. The master communication device 10 and the slave communication device 20 realize data communication through their respective external interfaces.

FIG. 2 is a schematic diagram of a master communication device 10 according to an embodiment of the present disclosure. As illustrated in FIG. 2, the master communication device 10 provided by embodiments of the present disclosure includes a dividing module 101, a sending module 102, a first timer 103, a receiving module 104 and a first determining module 105.

The dividing module 101 is configured to divide data to be sent into data packets.

The sending module 102 is configured to send the data packets to a slave communication device 20, and to start the first timer 103 after a last data packet is sent.

The first timer 103 is configured to count a time duration of a first preset time.

The receiving module 104 is configured to receive information sent by the slave communication device 20.

The first determining module 105 is configured to determine whether the receiving module 104 receives the information sent by the slave communication device 20 before the first timer 103 expires, and to trigger the sending module 102 to send control information to the slave communication device 20 to indicate the slave communication device 20 to respond to the control information if the receiving module 104 does not receive the information sent by the slave communication device 20 before the first timer 103 expires.

In detail, the master communication device 10 may divide the data to be sent into the data packets, and send all the data packets to the slave communication device 20 at one time, thus the amount of data transmitted at one time can be increased, and the number of data interaction can be reduced, thereby avoiding the problems that the slave communication device has to respond each time one data packet is received in the related art.

As an alternative implementation of embodiments of the present disclosure, when the dividing module 101 divides the data to be sent into the data packets, relevant information about a number of all data packets to be sent this time and/or a numbering of each data packet may be further included in the data packets, so that the slave communication device 20 can acquire complete data of the data to be sent. For example, the first data packet or the last data packet may include the relevant information about a number of all data packets to be sent this time, and each data packet may include the relevant information about the numbering of the data packet. After the slave communication device 20 receives all the data packets, the slave communication device 20 can acquire whether all the data packets are received according to the relevant information. Certainly, the master communication device 10 and the slave communication device 20 may also preset a number of all data packets to be sent at one time. In this case, only the relevant information about the numbering of the data packet is included in each data packet. The present disclosure does not limit the way in which the master communication device 10 and the slave communication device 20 acquire the number of the data packets and a position of each data packet, as long as a way enables the master communication device 10 and the slave communication device 20 to acquire the number of the data packets and the position of each data packet, the way shall fall within the protection scope of the present disclosure.

As an alternative implementation of embodiments of the present disclosure, when the dividing module 101 divides the data to be sent into the data packets, verification information of respective data packet may be included in each data packet, or verification information of all the data to be sent may be carried in the last data packet. As long as the slave communication device 20 can verify integrity of the received data, it should be within the protection scope of the present disclosure. The verification information may be a parity bit, a MAC value calculated by performing message authentication code (MAC) on the data, a signature value obtained by signing the data, or a value obtained by summing the data, as long as verification information and a verification way can realize integrity verification, the verification information and the verification way should be within the protection scope of the present disclosure.

As an alternative implementation of embodiments of the present disclosure, the sending module 102 may be further configured to start the first timer 103 after the last data packet is sent, so that the first determining module 105 can determine whether the receiving module 104 receives the information sent by the slave communication device 20 before the first timer 103 expires. The first timer 103 is configured to count the time duration of the first preset time. When the first determining module 105 determines whether the receiving module 104 receives the information sent by the slave communication device 20 before the first timer expires, the following two cases may be included.

Case One

When the first determining module 105 determines that the receiving module 104 does not receive the information sent by the slave communication device 20 before the first timer 103 expires, the first determining module 105 triggers the sending module 102 to send control information to the slave communication device 20 to indicate the slave communication device 20 to respond to the control information.

In this case, the first determining module 105 determines that the receiving module 104 does not receive the information sent by the slave communication device 20, and the following cases may occur.

(1) The slave communication device 20 does not receive the data packet. In this case, the slave communication device 20 cannot feed back information before the first timer 103 expires.

(2) The salve communication device 20 is processing received data packets, and the processing takes too long time, thus resulting in no information is fed back before the first timer 103 expires.

Thus, when the master communication device 10 determines that the receiving module 104 does not receive the information sent by the slave communication device 20 before the first timer 103 expires, the master communication device 10 triggers the sending module 102 to send the control information to the slave communication device 20 to indicate the slave communication device 20 to respond to the control information. The control information may indicate the slave communication device 20 to respond to the control information. For example, the control information may include relevant information querying why the slave communication device 20 did not feed back any information, so that the slave communication device 20 can respond to the control information to notify the master communication device 10 why the slave communication device 20 did not feed back any information, such as the slave communication device 20 does not receive the data packet, or the slave communication device 20 is still performing data processing, etc.

If the slave communication device 20 still does not respond to the control information after the master communication device 10 sends the control information to the slave communication device 20, it may be considered that there is a problem with connection between the master communication device 10 and the slave communication device 20. As an alternative implementation of embodiments of the present disclosure, referring to FIG. 3, in the master communication device 10, the sending module 102 is further configured to start a second timer 106 after sending the control information. The second timer 106 is configured to count a time duration of a second preset time. A second determining module 107 is configured to determine whether the receiving module 104 receives information sent by the slave communication device 20 before the second timer 106 expires. When it is determined that the receiving module 104 does not receive the information sent by the slave communication device 20 before the second timer 106 expires, a third determining module 108 is triggered. The third determining module 108 is configured to determine whether the number of times of sending the control information is greater than a preset threshold, and to trigger the sending module 102 to send the control information when the number of times of sending the control information is less than or equal to the preset threshold. In this case, since the master communication device 10 sets the threshold of the number of times of sending the control information, it is possible to prevent the master communication device 10 from repeatedly sending the control information. After the number of times of the master communication device 10 sending the control information is greater than the preset threshold, it may be considered that there is a problem with the connection between the master communication device 10 and the slave communication device 20, and the master communication device 10 can end this data interaction.

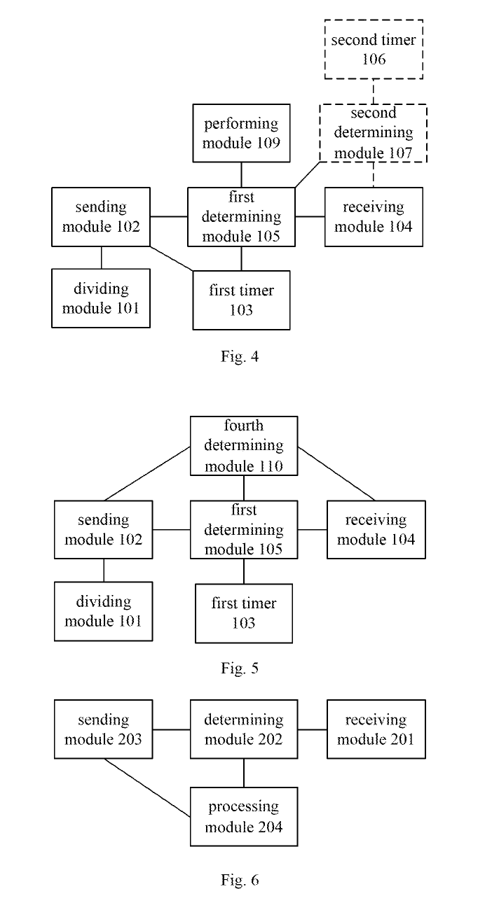

In an alternative implementation of embodiments of the present disclosure, referring to FIG. 4 (in combination with a part denoted by dotted lines), the second determining module 107 is configured to trigger the first determining module 105 to determine a type of the information sent by the slave communication device 20 when it is determined that the receiving module 104 receives the information sent by the slave communication device 20 before the second timer 106 expires. The first determining module 105 is further configured to determine the type of the information sent by the slave communication device 20. A performing module 109 is configured to perform a corresponding operation according to the type of the information sent by the slave communication device 20 determined by the first determining module 105. In detail, after the master communication device 10 sends the control information, the master communication device 10 may not receive information fed back by the slave communication device 20, and or may receive information fed back by the slave communication device 20. In this case, when the master communication device 10 receives the information fed back by the slave communication device 20 before the second timer 106 expires, the master communication device 10 determines the type of information fed back by the slave communication device 20. Certainly, the duration of the second timer 106 may be equal or unequal to the duration of the first timer 103, which may be set according to specific needs, and details are not described herein again.

Case Two

The first determining module 105 is further configured to determine the type of the information sent by the slave communication device 20 when the receiving module 104 receives the information sent by the slave communication device 20 before the first timer 103 expires. Referring to FIG. 4, the master communication device 10 may further include a performing module 109. The performing module 109 is configured to perform a corresponding operation according to the type of the information sent by the slave communication device 20 determined by the first determination module 105.

Based on the solutions of the performing module 10 involved in case one and case two, the performing module 109 performs the corresponding operation according to the type of the information sent by the slave communication device 20 in one of the following ways.

(1) When first determining module 105 determines that the type of the information sent by the slave communication device 20 and received by the receiving module 104 is control information indicating retransmission of the master communication device 10, the performing module 109 triggers the sending module 102 to resend part of or all of the data packets to the slave communication device 20 according to the information sent by the slave communication device 20.

(2) When the first determining module 105 determines that the type of the information sent by the slave communication device 20 and received by the receiving module 104 is control information indicating the master communication device 10 to wait, the performing module 109 waits for information sent by the slave communication device 20.

(3) When the first determining module 105 determines that the type of the information sent by the slave communication device 20 and received by the receiving module 104 is response data responding to the data to be sent, the performing module 109 determines whether the response data is complete. When it is determined that the response data is complete, the performing module 109 determines that current data transmission is finished. When it is determined that the response data is incomplete, the performing module 109 triggers the sending module 102 to send control information to the slave communication device 20 to indicate the slave communication device 20 to respond to the control information.

Thus, after the slave communication device 20 receives the data packets sent by the master communication device 10, following cases may occur.

(1) The data packets received by the salve communication device 20 are incomplete. In this case, the slave communication device 20 may send control information to the master communication device 10. The control information is configured to indicate the master communication device 10 to resend part of or all of the data packets. Thus, it can be ensured that the master communication device 10 can completely and correctly send all the data packets to the slave communication device 20.

As an alternative implementation of embodiments of the present disclosure, referring to FIG. 2 to FIG. 4, the sending module 102 is further configured to start the first timer 103 after resending part of or all of the data packets to the slave communication device 20, so that the first determining module 105 can further determine whether the master communication device 10 receives the information sent by the salve communication device 20 after sending the data packets. In other words, no matter whether the master communication device 10 sends all the data packets for the first time or resends the data packets, the master communication device 10 may determine whether the receiving module 104 receives the information sent by the slave communication device 20 before the first timer 103 expires, so as to ensure that the slave communication device 20 receives all the data packets completely and correctly.

(2) The data packets received by the slave communication device 20 are the complete data packets. Then, the slave communication device 20 processes the data packets. For example, the slave communication device 20 performs a signature operation on the data packets. Since a time duration that the salve communication device 20 processes the data packets may be greater than the time duration counted by the first timer 103, in order to prevent the master communication device 10 from repeatedly sending the control information, the salve communication device 20 may send control information to the master communication device 10 to indicate the master communication device 10 to wait. The master communication device 10 may wait for the information sent by the slave communication device 20 after receiving the control information. In this case, the information sent by the slave communication device 20 may still be the control information indicating the master communication device 10 to continue waiting, or may be data information obtained by processing the data packets sent by the master communication device 10.

As an alternative implementation of embodiments of the present disclosure, referring to FIG. 5, this embodiment may combine with structure of any one of FIG. 2 to FIG. 4. FIG. 5 is only described based on FIG. 2, and other components are not illustrated. In the master communication device 10, a fourth determining module 110 is configured to determine whether the receiving module 104 receives the information sent by the slave communication device 20 within a waiting time indicated by the control information indicating the master communication device 10 to wait after the receiving module 104 receives the control information indicating the master communication device 10 to wait. When the fourth determining module 110 determines that the receiving module 104 receives the information sent by the slave communication device 20 within the waiting time indicated by the control information indicating the master communication device 10 to wait, the first determining module 105 is triggered to determine the type of information sent by the slave communication device. When the fourth determining module 110 determines that the receiving module 104 does not receive the information sent by the slave communication device 20 within the waiting time indicated by the control information indicating the master communication device 10 to wait, the sending module 102 is triggered to send the control information to the slave communication device 20 to indicate the slave communication device 20 to respond to the control information. After the master communication device 10 receives the control information indicating the master communication device 10 to wait sent by the slave communication device 20, the slave communication device 20 may finish processing the data packets within the waiting time indicated by the control information, thus the slave communication device 20 may send processed data information to the master communication device 10 within the waiting time indicated by the control information. The slave communication device 20 may not complete processing the data packets within the waiting time indicated by the control information, thus the slave communication device 20 may continue to send the control information to indicate the master communication device 10 to continue waiting. Therefore, the master communication device 10 can determine whether the master communication device 10 receives the information sent by the slave communication device 20 within the waiting time. When the master communication device 10 receives the information sent by the slave communication device 20, the master communication device 10 determines the type of the information. When the master communication device 10 does not receive the information sent by the slave communication device 20, the master communication device 10 sends control information to the salve communication device 20, to indicate the salve communication device 20 to respond to the control information sent by the master communication device 10. Thus, it is possible to prevent the master communication device 10 from continuing waiting, and avoid a case that subsequent operations cannot be performed.

(3) The data packets received by the salve communication device 20 are complete data packets. The slave communication device 20 may feed back control information (for example, relevant information such as data integrity and the like) to the master communication device 10, to notify the master communication device 10 that the slave communication device 20 completely receives the information. The slave communication device 20 may also feed back data information (for example, data information obtained by the slave communication device 20 by processing the data packets) to the master communication device 10. When the information fed back by the slave communication device 20 is the data information, the master communication device 10 further determines whether corresponding data is complete. When the corresponding data is complete, it is determined that current data transmission is finished. When the corresponding data is incomplete, control information is further sent to the slave communication device 20, to indicate the slave communication device 20 to respond to the control information, such as resending part of or all of the data information, and the like. Thus, it can ensure that the information sent to the master communication device 10 by the slave communication device 20 is completely and correctly, and it can further ensure a complete information interaction from the master communication device 10 to the slave communication device 20 and then from the salve communication device 20 to the master communication device 10.

It can be seen that, in the present disclosure, when the master communication device 10 performs data interaction with the slave communication device 20, the number of times of data interaction can be reduced, and data interaction efficiency can be improved.

FIG. 6 is a schematic diagram of a slave communication device 20 according to an embodiment of the present disclosure. As illustrated in FIG. 6, the salve communication device 20 provided by embodiments of the present disclosure includes a receiving module 201, a determining module 202, a sending module 203 and a processing module 204.

The receiving module 201 is configured to receive data packets sent by a master communication device 10.

The determining module 202 is configured to determine whether the data packets are complete.

The sending module 203 is configured to send first control information to the master communication device 10 when the determining module 202 determines that the data packets are incomplete. The first control information is used to indicate retransmission of the master communication device 10.

The processing module 204 is configured to parse the data packets to obtain data transmitted by the data packets when the determining module 202 determines that the data packets are complete, to process the data to obtain response data and to send the response data to the master communication device 10 through the sending module 203.

In detail, after the slave communication device 20 receives the data packets sent by the master communication device 10, the salve communication device 20 may determine whether the data packets are complete, so as to ensure that the data packets received by the slave communication device 20 is correct. The salve communication device 20 can separately determine whether each data packet is complete, or can determine whether the data packets are complete together. The present disclosure is not limited to the way to determine integrity of the data packet, as long as a way can determine the integrity of multiple data packets, it should be within the protection scope of the present disclosure.

When the slave communication device 20 determines that the data packets are incomplete, the salve communication device 20 may send the first control information to the master communication device 10 to indicate the master communication device 10 to resend part of or all of the data packets. Only when it is determined that the data packets are complete, the salve communication device 20 may parse the data packets and process the data to obtain processed data. For example, the data sent to the slave communication device 20 by the master communication device 10 is data to be signed. After receiving the complete data to be signed, the slave communication device 20 may sign the data to be signed according to a confirmation instruction (for example, pressing, by a user, a confirmation button on the slave communication device 20 after the user confirms the data to be signed is correct via a display screen), to obtain signature data, and the slave communication device 20 may return the signature data to the master communication device 10. In this way, the problem of excessive times of data interaction and low data interaction efficiency caused by that the slave communication device 20 needs to respond every time the master communication device 10 sends a data packet can be avoided, such that the number of times of data interaction between the master communication device 10 and the slave communication device 20 can be reduced, and data interaction efficiency can be improved.

After the master communication device 10 sends the data packets, the slave communication device 20 may not receive the data packets sent by the master communication device 10 due to the connection problem or other problems. In this case, as an alternative implementation of embodiments of the present disclosure, in the slave communication device 20, the receiving module 201 is further configured to receive second control information sent by the master communication device 10 before receiving the data packets sent by the master communication device 10. The processing module 204 is further configured to respond to the second control information, and to send third control information to the master communication device 10 to indicate that the slave communication device 20 does not receive data sent by the master communication device 10. The slave communication device 20 may directly receive the second control information sent by the master communication device rather than the data packets. The second information is configured to query why the slave communication device 20 does not respond. Therefore, after the second control information is received, the salve communication device 20 may respond to the second control information, to send the third control information to the master communication device 10, to notify the master communication device 10 that the data sent by the master communication device 10 is not received. Thus, it is possible to avoid the problem that the salve communication device 20 does not receive the data packet, and the master communication device 10 keeps waiting for the feedback from the slave communication device 20, thereby improving data interaction efficiency and reducing power consumption.

The time duration that the salve communication device 20 processes the data packets may be greater than the preset time that the master communication device 10 sends the control information. In order to prevent the master communication device 10 from continuously sending the control information to the salve communication device 20, which leads to affect processing efficiency of the slave communication device 20, as an alternative implementation of the present disclosure, in the salve communication device 20, the sending module 203 is further configured to, when the determining modules 202 determines that the data packets are complete, send fourth control information to the master communication device 10 to indicate the master communication device 10 to wait for a preset time before sending the response data to the master communication device 10. Thus, the slave communication device 20 can notify the master communication device 10 that the slave communication device 20 is still processing the data packets, and may request the master communication device 10 to wait for the slave communication device 20 to process. In this case, the master communication device 10 can wait for information sent by the salve communication device 20 according to the fourth control information, thus improving data interaction efficiency.

After a first piece of fourth control information is sent, the slave communication device 20 may not finish processing the data packet within waiting time indicated by the fourth control information. In this case, the salve communication device 20 may resend the fourth control information, to notify the master communication device 10 to continue waiting, so as to avoid the master communication device 10 from sending the control information, which leads to affect the processing efficiency of the slave communication device 20. In this case, in the slave communication device 20, the sending module 201 is further configured to send the fourth control information to the master communication device 10 before the preset time arrives. The processed data is not sent to the master communication device 10 until the slave communication device 20 finishes processing the data packets. Certainly, the slave communication device 20 may finish processing the data packets after sending the first piece of fourth control information, or may finish processing the data packets after sending multiple fourth control information. Only after finishing processing the data packets, the slave communication device 20 may send the processed data to the master communication device 10.

In addition, when it is determined that the data packets are complete, the salve communication device 20 parses the data packets to obtain the data transmitted by the data packets. The salve communication device 20 processes the data to obtain response data and sends the response data to the master communication device 10 through the sending module 203. For example, the data transmitted by the data packets sent to the salve communication device 20 by the master communication device 10 is data to be signed. When it is determined that the data packets are complete, the slave communication device 20 parses the data packets to obtain the data to be signed transmitted by the data packets, and the slave communication device 20 displays the data to be signed via a display screen of the salve communication device 20 for the user to confirm. After the user confirms that displayed content is correct, the user may press the confirmation button to issue the confirmation instruction. The slave communication device 20 performs data processing steps according to the confirmation instruction. That is, the slave communication device 20 performs signature calculation on the data to be signed according to the confirmation instruction, to obtain the signature data. The obtained signature data is taken as the response data sent to the master communication device 10. Thus, a signature process is completed, i.e., a step in once data interaction is completed.

Certainly, when the slave communication device 20 sends the response data to the master communication device 10, verification information of respective data packet may be included in corresponding data packet of the response data, or verification information of all the response data may be carried in the last data packet. As long as the master communication device 10 can verify integrity of the received data, it should be within the protection scope of the present disclosure. The verification information may be a parity bit, a MAC value calculated by performing message authentication code (MAC) on the data, a signature value obtained by signing the data, or a value obtained by summing the data, as long as verification information and a verification way can achieve integrity verification, the verification information and the verification way should be within the protection scope of the present disclosure.

It can be seen that, in the present disclosure, when the slave communication device 20 performs data interaction with the master communication device 10, the number of times of data interaction can be reduced, and data interaction efficiency can be improved.

In the following, operations respectively performed by the master communication device and the slave communication device in the data transmission system will be briefly described, for those not described in detail, reference may be made to the above descriptions of the master communication device and the slave communication device.

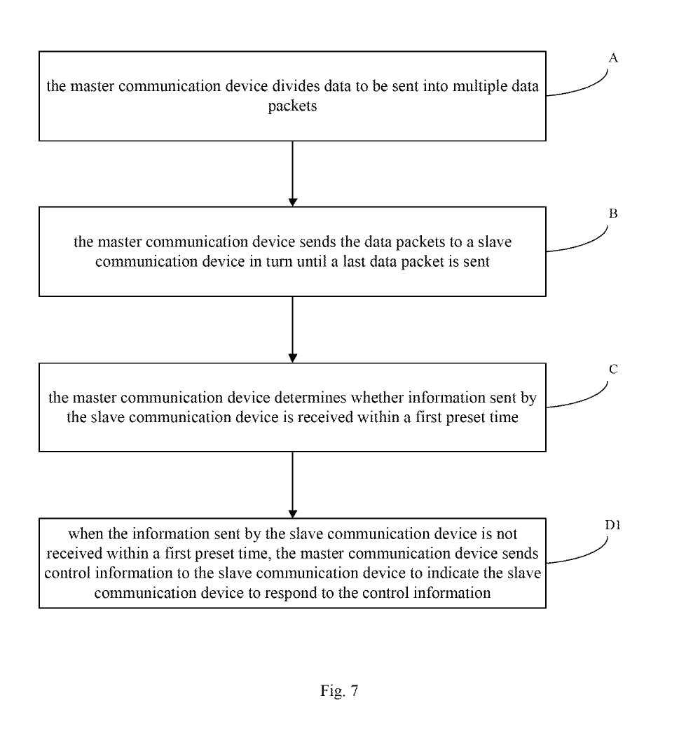

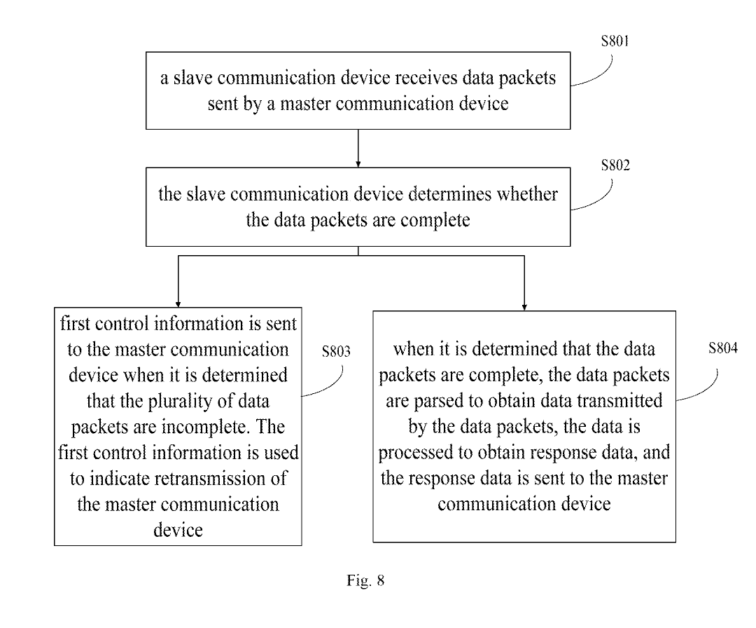

As a master communication device in a data transmission system, a data transmission method executed by the master communication device may refer to FIG. 7, which includes followings.

At step A, the master communication device divides data to be sent into multiple data packets.

At step B, the master communication device sends the data packets to a slave communication device in turn until a last data packet is sent.

At step C, the master communication device determines whether information sent by the slave communication device is received within a first preset time. Step D1 is performed when the information sent by the slave communication device is not received within a first preset time.

At step D1, when the information sent by the slave communication device is not received within a first preset time, the master communication device sends control information to the slave communication device to indicate the slave communication device to respond to the control information.

In detail, the master communication device may divide the data to be sent into the data packets, and send all the data packets to the slave communication device at one time, thus the amount of data transmitted at one time can be increased, and the number of data interaction can be reduced, thereby avoiding the problems that the salve device has to respond each time one data packet is received in the related art.

As an alternative implementation of embodiments of the present disclosure, when the master communication device divides the data to be sent into the data packets, relevant information about a number of all data packets to be sent this time and/or a numbering of each data packet may be further included in the data packets, so that the slave communication device can acquire complete data of the data to be sent. For example, the first data packet or the last data packet may include the relevant information about a number of all data packets to be sent this time, and each data packet may include the relevant information about the numbering of the data packet. After the slave communication device receives all the data packets, the slave communication device can acquire whether all the data packets are received according to the relevant information. Certainly, the master communication device and the slave communication device may also preset a number of all data packets to be sent at one time. In this case, only the relevant information about the numbering of the data packet may be included in each data packet. The present disclosure does not limit the way in which the master communication device and the slave communication device acquire the number of the data packets and a position of each data packet, as long as a way enable the master communication device and the slave communication device to acquire the number of the data packets and the position of each data packet, the way shall fall within the protection scope of the present disclosure.

As an alternative implementation of embodiments of the present disclosure, when the master communication device divides the data to be sent into the data packets, verification information of respective data packet may be included in each data packet, or verification information of all the data to be sent may be carried in the last data packet. As long as the slave communication device can verify integrity of the received data, it should be within the protection scope of the present disclosure. The verification information may be a parity bit, a MAC value calculated by performing message authentication code (MAC) on the data, a signature value obtained by signing the data, or a value obtained by summing the data, as long as verification information and a verification way can achieve integrity verification, the verification information and the verification way should be within the protection scope of the present disclosure.

As an alternative implementation of embodiments of the present disclosure, the master communication device determines at step C whether the information sent by the slave communication device is received within the first preset time. When the master communication device determines at step C whether the information sent by the slave communication device is received within the first preset time, the following two cases may be included.

Case One

When the information sent by the slave communication device is not received within the first preset time, step D1 is performed, i.e., the master communication device sends control information to the slave communication device to indicate the slave communication device to respond to the control information.

In this case, the master communication device determines that the master communication device does not receive the information sent by the salve communication device, and the following cases may occur.

(1) The slave communication device does not receive the data packet. In this case, the slave communication device cannot feed back information within the first preset time.

(2) The salve communication device is processing the received data packets, and the processing takes too long time, thus resulting in no information is fed back within the first preset time.

Thus, when the master communication device determines that the information sent by the slave communication is not received, the master communication device may send the control information to the slave communication device to indicate the slave communication device to respond to the control information. The control information may indicate the slave communication device to respond to the control information. For example, the control information may include relevant information querying why the slave communication device did not feed back any information, so that the slave communication device can respond to the control information to notify the master communication device why the slave communication device did not feed back any information, such as the slave communication device does not receive the data packet, or the slave communication device is still performing data processing, etc.

If the slave communication device still does not respond to the control information after the master communication device sends the control information to the slave communication device, it may be considered that there is a problem with connection between the master communication device and the slave communication device. As an alternative implementation of embodiments of the present disclosure, after step D1, the data transmission method of the master communication device further includes followings, which is not illustrated in drawings.

At step E1, the master communication device determines whether information sent by the slave communication device is received within a second preset time after sending the control information. Step F1 is performed when the information sent by the slave communication device is not received within the second preset time after sending the control information.

At step F1, it is determined whether the number of times of sending the control information is greater than a preset threshold. When the number of times of sending the control information is less than or equal to the preset threshold, step G is performed, otherwise, current data transmission is ended.

At step G, the master communication device continues to send control information to the slave communication device, and returns to step E1.

In this case, since the master communication device sets the threshold of the number of times of sending the control information, it is possible to prevent the master communication device from repeatedly sending the control information. After the number of times of the master communication device sending the control information is greater than the preset threshold, it may be considered that there is a problem with the connection between the master communication device and the slave communication device, and the master communication device can end this data interaction.

In an alternative implementation of embodiments of the present disclosure, at step E1, when the master communication device determines that the information sent by the slave communication device is received within the second preset time after sending the second control information, step F2 is performed.

At step F2, a type of the information sent by the slave communication device is determined, and a corresponding operation is performed according to the type of the information sent by the slave communication device.

Case Two (Not Illustrated in Drawings)

When the master communication device receives the information sent by the salve communication device within the first preset time, step D2 is performed.

At step D2, a type of the information sent by the slave communication device is determined, and a corresponding operation is performed according to the type of the information sent by the slave communication device.

As an alternative implementation of embodiments of the present disclosure, after step D1, the method further includes followings.

At step E1, the master communication device determines whether information sent by the slave communication device is received within a second preset time after sending the control information, and step F1 is performed when the information sent by the slave communication device is not received within the second preset time after sending the control information.

At step F1, it is determined whether the number of times of sending the control information is greater than a preset threshold, when the number of times of sending the control information is less than or equal to the preset threshold, step G is performed, otherwise, current data transmission is ended.

At step G, the master communication device continues to send control information to the slave communication device, and returns to step E1.

In step E1, step F2 is further performed when the information sent by the slave communication device is received within the second preset time after sending the control information.

At step F2, a type of the information sent by the slave communication device is determined, and a corresponding operation is performed according to the type of the information sent by the slave communication device.

Step F2 in this operation may be step D2 in the above operation, and step F2 and step D2 may be same steps. In the following, step F2 is directly described as step D2.

In detail, after the master communication device sends the control information, the master communication device may not receive information fed back by the slave communication device, or may receive information fed back by the slave communication device. In this case, when the master communication device receives the information fed back by the slave communication device within the second preset time, the master communication device determines the type of information fed back by the slave communication device. Certainly, the second preset time may be equal or unequal to the first preset time, and may be set according to specific needs, details are not described herein again.

Based on the two alternative solutions of case two, in step D2, the master communication device performs the corresponding operation according to the type of the information sent by the salve communication device, following cases may be included.

(1) When the master communication device confirms that the type of the information sent by the salve communication device is control information indicating retransmission of the master communication device, the master communication device resends part of or all of the data packets to the slave communication device according to the information sent by the slave communication device.

(2) When the master communication device confirms that the type of the information sent by the salve communication device is control information indicating the master communication device to wait, the master communication device waits for information sent by the salve communication device.

(3) When the master communication device confirms that the type of the information sent by the slave communication device is response data responding to the data to be sent, the master communication device determines whether the response data is complete. When it is determined that the response data is complete, it is determined that current data transmission is finished, and when it is determined that the response data is incomplete, step D1 is returned to.

Thus, after the slave communication device receives the data packets sent by the master communication device, following cases may occur.

(1) The data packets received by the salve communication device are incomplete. In this case, the slave communication device may send control information to the master communication device. The control information is configured to indicate the master communication device to resend part of or all of the data packets. Thus, it can be ensured that the master communication device can completely and correctly send all the data packets to the slave communication device.

As an alternative implementation of embodiments of the present disclosure, after the master communication device resends part of or all of the data packets to the slave communication device according to the information sent by the slave communication device, the data transmission method of the master communication device further includes (not shown in drawings): returning to performing step C, i.e., the master communication device determines whether the information sent by the slave communication device is received within the first preset time. In other words, no matter whether the master communication device sends all the data packets for the first time or resends the data packets, the master communication device may determine whether the information sent by the slave communication device is received within the first preset time, so as to ensure that the slave communication device receives all the data packets completely and correctly.

(2) The data packets received by the slave communication device are the complete data packet. Then, the slave communication device processes the data packets. For example, the slave communication device performs a signature operation on the data packets. Since a time duration that the salve communication device processes the data packets may be greater than the first preset time, in order to prevent the master communication device from repeatedly sending the control information, the salve communication device may send control information to the master communication device to indicate the master communication device to wait. The master communication device may wait for the information sent by the slave communication device after receiving the control information. In this case, the information sent by the slave communication device may still be the control information indicating the master communication device to continue waiting, or may be data information obtained by processing the data packets sent by the master communication device.

As an alternative implementation of embodiments of the present disclosure, after the master communication device receives the information indicating the master communication device to wait, the data transmission method of the master communication device further includes followings (not illustrated in drawings).

The master communication device determines whether the information sent by the salve communication device is received within a waiting time indicated by the control information indicating the master communication device to wait. If yes, the step of determining the type of the information sent by the slave communication device is returned to. If not, step D1 is returned to, i.e., the master communication device sends control information to the slave communication device to indicate the slave communication device to respond to the control information. After the master communication device receives the control information indicating the master communication device to wait sent by the slave communication device, the slave communication device may finish processing the data packets within the waiting time indicated by the control information, thus the slave communication device may send processed data information to the master communication device within the waiting time indicated by the control information. The slave communication device may not complete processing the data packets within the waiting time indicated by the control information, thus the slave communication device may continue to send the control information to indicate the master communication device to continue waiting. Therefore, the master communication device can determine whether the information sent by the slave communication device is received within the waiting time. When the information sent by the slave communication device is received within the waiting time, the type of the information is determined. When the information sent by the slave communication device is not received within the waiting time, the master communication device sends control information to the salve communication device, to indicate the salve communication device to respond to the control information sent by the master communication device. Thus, it is possible to prevent the master communication device from continuing waiting, and avoid a case that subsequent operations cannot be performed.

(3) The data packets received by the salve communication device are complete data packets. The slave communication device may feed back control information (for example, relevant information such as data integrity and the like) to the master communication device, to notify the master communication device that the slave communication device completely receives the information. The slave communication device may also feed back data information (for example, data information obtained by the slave communication device by processing the data packets) to the master communication device. When the information fed back by the slave communication device is the data information, the master communication device further determines whether corresponding data is complete. When the corresponding data is complete, it is determined that current data transmission is finished. When the corresponding data is incomplete, control information is further sent to the slave communication device, to indicate the slave communication device to respond to the control information, such as resending part of or all of the data information, and the like. Thus, it can ensure that the information sent to the master communication device by the slave communication device is completely and correctly, and it can further ensure a complete information interaction from the master communication device to the slave communication device and then from the salve communication device to the master communication device.

It can be seen that, with the data transmission method of the master communication device according to embodiments of the present disclosure, when the master communication device performs data interaction with the slave communication device, the number of times of data interaction can be reduced, and data interaction efficiency can be improved.

As a salve communication device in the data transmission system, a data transmission method executed by the salve communication device may refer to FIG. 8, which may include followings.

At block S801, a slave communication device receives data packets sent by a master communication device.

At block S802, the slave communication device determines whether the data packets are complete.

At block S803, first control information is sent to the master communication device when it is determined that the data packets are incomplete. The first control information is used to indicate retransmission of the master communication device.

At block S804, when it is determined that the data packets are complete, the data packets are parsed to obtain data transmitted by the data packets, the data is processed to obtain response data, and the response data is sent to the master communication device.

In detail, after the data packets sent by the master communication device is received by the slave communication device, the salve communication device may determine whether the data packets are complete, so as to ensure that the data packets received by the slave communication device are correct. The salve communication device can separately determine whether each data packet is complete, or can determine whether the data packets are complete together. The present disclosure is not limited to the way to determine integrity of the data packet, as long as a way can determine the integrity of multiple data packets, it should be within the protection scope of the present disclosure.

When the slave communication device determines that the data packets are incomplete, the salve communication device may send the first control information to the master communication device. The first control information is used to indicate the master communication device to resend part of or all of the data packets. Only when it is determined that the data packets are complete, the salve communication device may parse the data packets and process the data to obtain processed data. For example, the data sent to the slave communication device by the master communication device is data to be signed. After receiving the complete data to be signed, the slave communication device may sign the data to be signed according to a confirmation instruction (for example, pressing, by a user, a confirmation button on the slave communication device after the user confirms the data to be signed via a display screen is correct), to obtain signature data, and the slave communication device may return the signature data to the master communication device. In this way, the problem of excessive times of data interaction and low data interaction efficiency caused by that the slave communication device needs to respond every time the master communication device sends a data packet can be avoided, such that the number of times of data interaction between the master communication device and the slave communication device can be reduced, and data interaction efficiency can be improved.

After the master communication device sends the data packets, the slave communication device may not receive the data packets sent by the master communication device due to the connection problem or other problems. In this case, as an alternative implementation of embodiments of the present disclosure, at block S801, before the slave communication device receives the data packets sent by the master communication device, the data transmission method of the slave communication device further includes followings (not illustrated in drawings).

At block S8001, the slave communication device receives second control information sent by the master communication device.

At block S8002, the slave communication device responds to the second control information, and sends third control information to the master communication device to indicate that the slave communication device does not receive the data sent by the master communication device.

The slave communication device may directly receive the second control information sent by the master communication device rather than the data packets. The second information is configured to query why the slave communication device does not respond. Therefore, after the second control information is received, the salve communication device may respond to the second control information, to send the third control information to the master communication device, to notify the master communication device that the data sent by the master communication device is not received. Thus, it is possible to avoid the problem that the salve communication device does not receive the data packet, and the master communication device keeps waiting for the feedback from the slave communication device, thereby improving data interaction efficiency and reducing power consumption.

The time duration that the salve communication device processes the data packets may be greater than the preset time that the master communication device sends the control information, in order to prevent the master communication device from continuously sending the control information to the salve communication device, which leads to affect processing efficiency of the slave communication device, as an alternative implementation of the present disclosure, when it is determined that the data packet are complete, and before sending the response data to the master communication device at block S804, the data transmission method of the slave communication device may further include followings (not illustrated in drawings).

At block S8041, the slave communication device sends fourth control information to the master communication device, to indicate the master communication device to wait for a preset time.

Thus, the slave communication device can notify the master communication device that the slave communication device is still processing the data packets, and may request the master communication device to wait for the slave communication device to process. In this case, the master communication device can wait for information sent by the salve communication device according to the fourth control information, thus improving data interaction efficiency.

After a first piece of fourth control information is sent, the slave communication device still does not finish processing the data packet before waiting time indicated by the fourth control information arrives. In this case, the salve communication device may resend the fourth control information, to notify the master communication device to continue waiting, so as to avoid the master communication device from sending the control information, which leads to affect the processing efficiency of the slave communication device. In this case, before the preset time arrives, the data transmission method of the slave communication device further includes: the slave communication device sends the fourth control information to the master communication device. The processed data is not sent to the master communication device until the slave communication device 20 finishes processing the data packets. Certainly, the slave communication device may finish processing the data packets after sending the first piece of fourth control information, or may finish processing the data packets after sending multiple fourth control information. Only after finishing processing the data packets, the slave communication device may send the processed data to the master communication device.

In addition, when it is determined that the data packets are complete, the salve communication device parses the data packets to obtain the data transmitted by the data packets. The salve communication device processes the data to obtain response data and sends the response data to the master communication device. For example, the data transmitted by the data packets sent to the salve communication device by the master communication device is data to be signed. When it is determined that the data packets are complete, the slave communication device parses the data packets to obtain the data to be signed transmitted by the data packets, and displays information to be signed via a display screen of the salve communication device for the user to confirm. After the user confirms that displayed information is correct, the user may press the confirmation button to issue the confirmation instruction. The slave communication device performs data processing steps according to the confirmation instruction. That is, the slave communication device performs signature calculation on the signature information to be signed according to the confirmation instruction, to obtain the signature data. The obtained signature data is taken as the response data sent to the master communication device. Thus, a signature process is completed, i.e., a step in a data interaction is completed.

Certainly, when the slave communication device sends the response data to the master communication device, verification information of respective data packet may be included in corresponding data packet of the response data, or verification information of all the response data may be carried in the last data packet. As long as the master communication device can verify integrity of the received data, it should be within the protection scope of the present disclosure. The verification information may be a parity bit, a MAC value calculated by performing message authentication code (MAC) on the data, a signature value obtained by signing the data, or a value obtained by summing the data, as long as verification information and a verification way can achieve integrity verification, the verification information and the verification way should be within the protection scope of the present disclosure.

It can be seen that, with the data transmission method of the slave communication device according to embodiments of the present disclosure, when the master communication device performs data interaction with the slave communication device, the number of times of data interaction can be reduced, and data interaction efficiency can be improved.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, in which, the functions may be performed in the order shown or discussed which should be understood by persons of ordinary skill in the art. The functions may not be performed in the order shown or discussed, including in substantially simultaneous or reverse order according to the functions involved, as understood by those skilled in the art to which the embodiments of the present disclosure belongs.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Persons of skilled in the art shall understand that all or parts of the steps in the in the method of the above embodiments may be achieved by commanding the related hardware with programs. The programs may be stored in a computer readable storage medium, and the programs include one step or a combination of the steps in the method embodiments when the program is executed.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks or CD, etc.

Reference throughout this specification to “an embodiment,” “some embodiments,” “an example,” “a specific example,” or “some examples,” means that a particular feature, structure, material, or characteristic described in connection with the embodiment or example is included in at least one embodiment or example of the present disclosure. Thus, the appearances of the above phrases in various places throughout this specification are not necessarily referring to the same embodiment or example of the present disclosure. Furthermore, the particular features, structures, materials, or characteristics may be combined in any suitable manner in one or more embodiments or examples.

Although embodiments of the present disclosure have been shown and described, it would be appreciated by persons of ordinary skill in the art that the above embodiments are explanatory, and cannot be construed to limit the present disclosure, and changes, alternatives, and modifications can be made in the embodiments without departing from scope of the present disclosure.

1. A data transmission method, comprising:
dividing, by a master communication device, data to be sent into data packets;
sending, by the master communication device, the data packets to a slave communication device in turn until a last data packet is sent;
determining, by the master communication device, whether information sent by the slave communication device is received within a first preset time; and
when the information sent by the slave communication device is not received within the first preset time, sending, by the master communication device, control information to the slave communication device to indicate the slave communication device to respond to the control information.

2. The method according to claim 1, after sending, by the master communication device, control information to the slave communication device to indicate the slave communication device to respond to the control information, further comprising:
determining, by the master communication device, whether information sent by the slave communication device is received within a second preset time after the control information is sent;
when the information sent by the slave communication device is not received within the second preset time, determining whether a number of times of sending the control information is greater than a preset threshold
when the number of times of sending the control information is less than or equal to the preset threshold, sending, by the master communication device, the control information to the slave communication device, and returning to the step of determining, by the master communication device, whether information sent by the slave communication device is received within a second preset time after the control information is sent
when the number of times of sending the control information is greater than the preset threshold, ending current data transmission; and
when the information sent by the slave communication device is received within the second preset time after the control information is sent, determining a type of the information sent by the slave communication device, and performing a corresponding operation according to the type of the information sent by the slave communication device.

3. (canceled)

4. The method according to claim 1, further comprises:
when the information sent by the slave communication device is received within the first preset time,
determining a type of the information sent by the slave communication device, and performing a corresponding operation according to the type of the information sent by the slave communication device.

5. The method according to claim 3, wherein, performing the corresponding operation according to the type of the information sent by the slave communication device comprises:
resending, by the master communication device, part of or all of the data packets to the slave communication device according to the information sent by the slave communication device when the master communication device confirms that the type of the information sent by the salve communication device is control information indicating retransmission of the master communication device; and
after resending, by the master communication device, part of or all of the data packets to the slave communication device according to the information sent by the slave communication device, returning to the step of determining, by the master communication device, whether information sent by the slave communication device is received within a first preset time.

6. (canceled)

7. The method according to claim 3, wherein, performing the corresponding operation according to the type of the information sent by the slave communication device comprises:
waiting, by the master communication device, for information sent by the salve communication device when the master communication device confirms that the type of the information sent by the salve communication device is control information indicating the master communication device to wait.

8. The method according to claim 7, after receiving, by the master communication device, the control information indicating the master communication device to wait, further comprising:
determining, by the master communication device, whether information sent by the slave communication device is received within a waiting time indicated by the control information indicating the master communication device to wait, if so, returning to perform the step of determining the type of the information sent by the slave communication device, otherwise, returning to perform the step of sending, by the master communication device, control information to the slave communication device to indicate the slave communication device to respond to the control information.

9. The method according to claim 3, wherein, performing the corresponding operation according to the type of the information sent by the slave communication device comprises:
when the master communication device confirms that the type of the information sent by the slave communication device is response data responding to the data to be sent, determining, by the master communication device, whether the response data is complete;
when the master communication device determines that the response data is complete, confirming that current data transmission is finished; and
when the master communication device determines the response data is incomplete, returning to perform the step of sending, by the master communication device, control information to the slave communication device to indicate the slave communication device to respond to the control information.

10. A data transmission method, comprising:
receiving, by a slave communication device, data packets sent by a master communication device;
determining, by the slave communication device, whether the data packets are complete;
sending first control information to the master communication device when the slave communication device determines that the data packets are incomplete, wherein the first control information is used to indicate retransmission of the master communication device; and
parsing, by the slave communication device, the data packets to obtain data transmitted by the data packets, processing the data to obtain response data, and sending the response data to the master communication device, when the slave communication device determines that the data packets are complete.

11. The method according to claim 10, before receiving, by the slave communication device, the data packets sent by the master communication device, further comprising:
receiving, by the slave communication device, second control information sent by the master communication device; and
responding, by the slave communication device, to the second control information, and sending third control information to the master communication device to indicate that the slave communication device does not receive the data sent by the master communication device.

12. The method according to claim 10, before sending the response data to the master communication device when the slave communication device determines that the data packets are complete, further comprising:
sending, by the slave communication device, fourth control information to the master communication device, wherein the fourth control information is used to indicate the master communication device to wait for a preset time.

13. The method according to claim 12, before the preset time arrives, further comprising:
sending, by the slave communication device, the fourth control information to the master communication device.

14. A master communication device, comprising one or more processors, wherein the one or more processors comprise:
a dividing module, configured to divide data to be sent into data packets;
a first timer, configured to count a time duration of a first preset time;
a sending module, configured to send the data packets to a slave communication device in turn, and to start the first timer when a last data packet is sent;
a receiving module, configured to receive information sent by the slave communication device; and
a first determining module, configured to determine whether the receiving module receives the information sent by the slave communication device before the first timer expires, and to trigger the sending module to send control information to the slave communication device to indicate the slave communication device to respond to the control information when the receiving module does not receive the information sent by the slave communication device before the first timer expires.

15. The master communication device according to claim 14, wherein,
the sending module is further configured to start a second timer after sending the control information;
the master communication device further comprises:
the second timer, configured to count a time duration of a second preset time;
a second determining module, configured to determine whether the receiving module receives information sent by the slave communication device before the second timer expires, and to trigger a third determining module when the receiving module does not receive the information sent by the slave communication device before the second timer expires; and
the third determining module, configured to determine whether a number of times of sending the control information is greater than a preset threshold, and to trigger the sending module to send the control information when the number of times of sending the control information is less than or equal to the preset threshold.

16. The master communication device according to claim 15, wherein,
the second determining module is further configured to trigger the first determining module to determine a type of the information sent by the slave communication device when the second determining module determines that the receiving module receives the information sent by the slave communication device before the second timer expires;
the first determining module is further configured to determine the type of the information sent by the slave communication device;
the master communication device further comprises:
a performing module, configured to perform a corresponding operation according to the type of the information sent by the slave communication device determined by the first determining module.

17. The master communication device according to claim 14, wherein,
the first determining module is further configured to determine the type of the information sent by the slave communication device when the receiving module receives the information sent by the slave communication device before the first timer expires;
the master communication device further comprises:
a performing module, configured to perform a corresponding operation according to the type of the information sent by the slave communication device determined by the first determining module.

18. The master communication device according to claim 16, wherein the performing module performs the corresponding operation according to the type of the information sent by the slave communication device by:
triggering the sending module to resend part of or all of the data packets to the slave communication device according to the information sent by the slave communication device when the first determining module confirms that the type of the information sent by the slave communication device and received by the receiving module is control information indicating retransmission of the master communication device.

19. The master communication device according to claim 18, wherein the sending module is further configured to start the first timer after resending part of or all of the data packets to the slave communication device.

20. The master communication device according to claim 16, wherein the performing module performs the corresponding operation according to the type of the information sent by the slave communication device by:
waiting for information sent by the slave communication device when the first determining module confirms that the type of the information sent by the slave communication device and received by the receiving module is control information indicating the master communication device to wait.

21. The master communication device according to claim 20, further comprising:
a fourth determining module, configured to, after the receiving module receives the control information indicating the master communication device to wait, determine whether the receiving module receives information sent by the slave communication device within a waiting time indicated by the control information indicating the master communication device to wait;
when the fourth determining module determines that the receiving module receives the information sent by the slave communication device within the waiting time indicated by the control information indicating the master communication device to wait, the fourth determining module is configured to trigger the first determining module to determine the type of the information sent by the slave communication device;
when the fourth determining module determines that the receiving module does not receive the information sent by the slave communication device within the waiting time indicated by the control information indicating the master communication device to wait, the fourth determining module is configured to trigger the sending module to send control information to the slave communication device to indicate the slave communication device to respond to the control information.

22. The master communication device according to claim 16, wherein the performing module performs the corresponding operation according to the type of the information sent by the slave communication device by:
when the first determining module confirms that the type of the information sent by the slave communication device and received by the receiving module is response data responding to the data to be sent, determining whether the response data is complete, when the performing module determines that the response data is complete, confirming that current data transmission is finished, and when the performing module determines that the response data is incomplete, triggering the sending module to send control information to the slave communication device to indicate the slave communication device to respond to the control information.

23-28. (canceled)
